(19) United States
(12) Patent Application Publication
(10) Pub. No.: US 2002/0032634 A1
(43) Pub. Date: Mar. 14, 2002

(54) Method and system for online live auctions

(76) Inventors: Howard Allan Abrams, San Mateo, CA (US); Jonathan B. Lindo, Los Altos, CA (US); Payton R. White, Palo Alto, CA (US); Mark Christian Barnes, Sunnyvale, CA (US); Geoffrey F. Graber, San Francisco, CA (US); Gavin S.H. Cheng, San Francisco, CA (US)

Correspondence Address: Glenn E. Von Tersch, BLAKELY, SOKOLOFF, TAYLOR & ZAFMAN LLP, 7th Floor, 12400 Wilshire Boulevard, Los Angeles, CA, 90025, US

(21) Appl. No.: 09/752,585

(22) Filed: Dec. 27, 2000

Related U.S. Application Data
(63) Continuation-in-part of application No. 09/659,215, filed on Sep. 11, 2000.

(51) Int. Cl. G06F 17/60

(52) U.S. Cl. 705/37

(57) ABSTRACT

A method and system for providing online live auctions platform is disclosed. The online live auction platform is provided among a group of bidders having similar or same interests or in one or more virtual communities. An auction process starts in a first community that permits a member of a first virtual community to list an auctioned item for bidding. All members in the first virtual community can participate in the bidding and members in a second virtual community may participate in the bidding by becoming part of the first virtual community or through one of the members in the first virtual community.

### CROSS-REFERENCE TO RELATED APPLICATIONS

This application is a continuation-in-part of a pending U.S. patent application entitled “Online Live Search Systems” on Sep. 11, 2000, having a Ser. No. ______, which is assigned to the same assignee as the present application and hereby incorporated by reference.

### BACKGROUND OF THE INVENTION

1. Field of the Invention

The present invention relates generally to the area of distributed virtual networks and more specifically to a method or system for providing live online auctions.

2. Description of the Related Art

U.S. Pat. No. 3,581,072, which issued on Mar. 25, 1971, describes one of the first computer driven auction-matching systems for fungible goods. This reference describes a pricing system where priced orders to buy are arranged in descending order by price and priced orders to sell are also arranged in descending order by price within each price range, with all orders being arranged in descending order by time of placement so the older orders are upper most. Further, all compatibly priced orders are then matched starting with the highest price order to buy and the lowest price order to sell and proceeding sequentially until all compatibly priced pairs of orders have been matched. Ordering and matching types of actions are performed efficiently by computers with the outcome being controlled by pre-stored rule sets which designate the variable (i.e., price) to be optimized.

The era of the online auction would have to wait almost a quarter of a century for the emergence of eBay, Inc. Founded in 1995, ebaY™ is the largest and most successful Web-based auction houses offering more than 4.5 million listings and 10 million registered users. The success of ebaY™ has resulted in a flood of similar ventures by numerous competitors, such as Amazon.com, seeking similar successes.

These online auctions in fact have no similarity with the traditional auctions in which an auction item is announced for bidding in front of a group of bidders in real time. These online auction sites act more or less as a broker that lists all kinds of auction items for bidding for a fixed period of time. The broker takes a cut from the bidding price after one of the auction items is gone. There are a number of disadvantages in such online auctions. First, there are no more person-to-person interactions, everything through a proxy server (i.e. the broker server), lacking of the real auction excitement. Second, often an auction item could not be appreciated by the bidders that come virtually from all over the world with varying culture backgrounds and interests, the start bidding price could be hardly justified in some cases.

What is needed is an auction system in which bidders share similar interest and the auction system permits live bidding among the bidders. In addition, it would be desirable that the middle broker is no longer needed in such auction system.

### SUMMARY OF THE INVENTION

The present invention relates to a method and system for providing live online auctions, particularly among a group of bidders having similar or same interests or in one or more virtual communities. According to one embodiment, the live online action platform or system is based on one or more virtual communities. An auction process starts in a first community that permits a member of a first virtual community to list an auctioned item for bidding. All members in the first virtual community can participate in the bidding and members in a second virtual community may participate in the bidding as well by becoming part of the first virtual community or through one of the members in the first virtual community.

According to another embodiment, the online auction system permits a first member of a first virtual community to access the directories and resources of other members in the first virtual community for auctioned items. Through a joint or gateway member, the first member may access the directories and resources of members in a second virtual community for the purpose of interacting in an online auction having items for sale and bids from both virtual communities. Additionally, either the second member or a manager for the second virtual community may establish restrictions and use conditions for the proxy access rights granted.

The virtual communities or groups are formed as a result of users identifying other users with similar information resources, similar interests, pre-existing relationships or other common characteristics. These communities or groups may be also formed as a result of users indicating a desire to join such a group, being invited to join such a group or the groups may form as users discover common characteristics. This grouping may be representative of a first user having knowledge of how to contact a second user and means to contact the second user (such as contacting the second user through use of the Internet for example).

The present invention may be implemented as a system, a method, or a computer product, each yielding one or more of the following advantages or benefits. One of them is that the person-to-person interaction in the online actions is emphasized. Another one is the possible elimination of a middle broker. As a result, auction items are self-promoted and auctioned among one or more communities. Still another one is that auction items have high affinity with the background of the possible bidders so that the auction items are more appreciated.

The foregoing and other benefits, advantages, objects, and features of the invention will become more apparent from the following detailed description of the invention, which proceeds with reference to the accompanying drawings.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram of a networked communications system that may be used to implement a method and system embodying the invention;

FIG. 2 illustrates a representative user interface application (a browser application) associated with entering and maintaining community membership information that may be used in conjunction with an embodiment of the present invention;

FIG. 3 illustrates a representative file setup that may be used to segregate member files into a public directory and a private directory which may be used in conjunction with an embodiment of the present invention;

FIG. 4 illustrates a representative user interface application (a browser application) associated with interacting with a community auction bulletin board that may be used in conjunction with an embodiment of the present invention;

FIG. 5 illustrates a representative user interface application (a search utility) associated with a composite community email list which may be used in conjunction with an embodiment of the present invention;

FIG. 6 illustrates a representative conceptualization of the relationship between a client member terminal device and a gateway member terminal device in conjunction with an embodiment of the present invention;

FIG. 7 is flow diagram of the process associated with responding to a request for content from community and non-community members in accordance with an embodiment of the present invention; and

FIG. 8 is flow diagram of the process associated with local processing of received content in accordance with an embodiment of the present invention.

### DETAILED DESCRIPTION OF THE INVENTION

The invention pertains to a method and system for providing a live online auction platform among bidders having similar interests. The invention may be advantageously employed for groups of users or virtual communities over the Internet. According to one embodiment, the live online action platform or system is based on one or more virtual communities. An auction process starts in a first community that permits a member of a first virtual community to list an auctioned item for bidding. All members in the first virtual community can participate in the bidding and members in a second virtual community may become members of the first virtual community to participate in the bidding as well or alternatively through one of the members in the first virtual community.

According to another embodiment, the online auction system permits a first member of a first virtual community to access the directories and resources of other members in the first virtual community for auctioned items. Through a joint or gateway member, the first member may access the directories and resources of members in a second virtual community for the purpose of interacting in an online auction having items for sale and bids from both virtual communities. Additionally, either the second member or a manager for the second virtual community may establish restrictions and use conditions for the proxy access rights granted.

Directory clients and directory servers resident on terminal devices associated with community members may facilitate this access using a content sharing protocol such as Lightweight Device Access Protocol (LDAP), DBMS protocol or other filesharing protocol such as Napster, Gnutella, HTTP, and an extension thereof. Additionally, the gateway access provided to the client member may be selectively provided through a gateway member concurrently online or through a time sensitive mirror image of the gateway member's public files resident on a community server device.

Terminal devices, also referred to as communication devices herein, include but are not limited to personal computers, laptop computers, computer terminals, computer work stations, personal digital assistants, palm-sized computing devices and cellular telephones. Such devices typically have a user interface comprised of a display, a keyboard and a pointing device (e.g., a mouse, a trackball, a joystick, a navigation key-set or a touch-pad). Network interactions for these devices quite often involve some type of a browser (i.e., Netscape, Internet Explorer, Opera or StarOffice) or micrbrowser (i.e., a WAP compliant microbrowser).

The detailed description of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

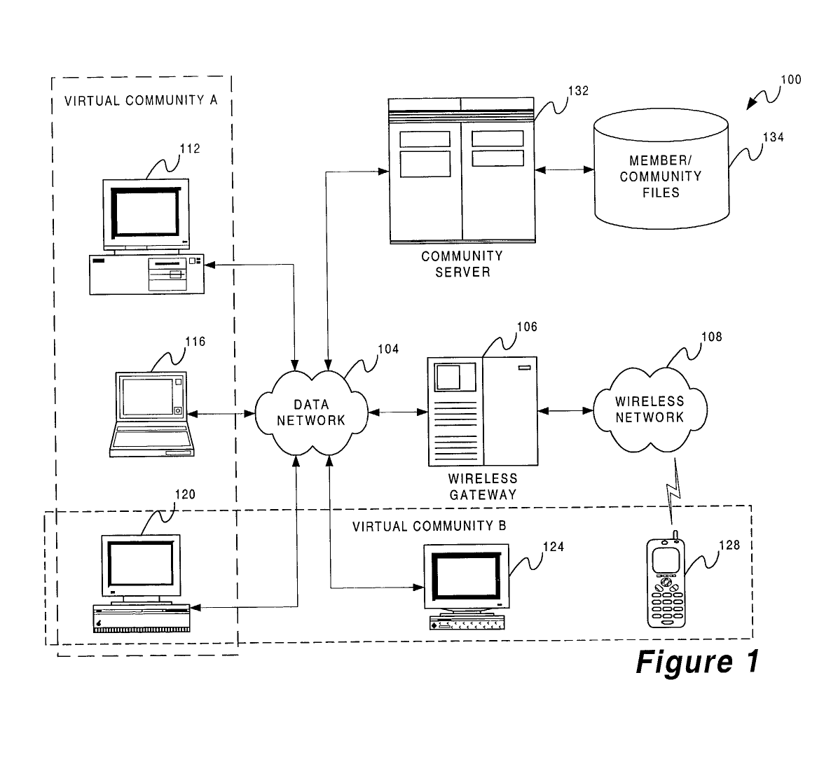

Referring now to the drawings, in which like numerals refer to like parts throughout the several views. FIG. 1 is a block diagram of a network communications system 100 that may be used to implement a method and system embodying the invention. Network communications system 100 generally includes one or more networks such as data network 104 (i.e., a TCP/IP network) and wireless network 108 (i.e., GSM, CDMA, TDMA, PHS wireless networks, etc.) that facilitate communications between a plurality of networked terminal devices as is illustrated by terminal devices 112, 116, 120, 124 and 128. Communications between devices serviced by data network 104 and wireless network 108 is facilitated through the use of wires gateway 106 (i.e., a WAP gateway).

The plurality of networked terminal devices may be arranged in virtual communities where the members share some common interest (i.e., music, sports, politics, finances) and community activities such as those activities related to online auctions. In the illustration provided in FIG. 1, Virtual Community A is comprised of terminal devices 112,116 and 120 and Virtual Community B is comprised of terminal device 120, 124 and 128. Terminal device 120 is common to both Virtual Community A and Virtual Community B and sometimes referred to as a joint member or a gateway member.

Unless otherwise specifically stated, members of a community may interchangeably mean a computing device coupled to the community or a user thereof in communication with the community. According to one aspect of the present invention, a terminal device in Virtual Community A, such as terminal devices 112 or 116 or users thereof, typically do not have the access privilege to Virtual Community B. By requesting the access through terminal device 120, terminal devices in Virtual Community A may gain access to the resources in Virtual Community B, wherein terminal device 120 is a member of both communities A and B, referring to as a joint or gateway member herein.

According to one embodiment, the gateway member or the administrator for Virtual Community B may selectively control the level of access to the community resources and the conditions for the use of the resources. Community specific program applications running on a gateway member device may enforce the use conditions of community information by proxy community members (i.e., client devices accessing a community through the gateway member device). Additionally, a mirror of the gateway member's public files may be maintained on a remote server device (i.e., community server device 132 and associated storage 134) that may be utilized to enable gateway activity when the gateway member is off-line.

A client terminal device (i.e., terminal devices 112 or 116) may gain access to the access privileges of a gateway terminal device (i.e., terminal device 120) through the use of a content sharing protocol such as Lightweight Device Access Protocol (LDAP). LDAP defines a message protocol that is used to facilitate an interaction between a directory server (i.e. terminal device 120) and a directory client (i.e., terminal device 112). LDAP agents are available for windows environments, UNIX environments and java environments. An example of a directory server that may be used with the present invention is an LDAP compliant server such as Netscape's DIRECTORY SERVER. One skilled in the art would realize that the same function may be obtained using a standard database management server (DBMS) such as is sold by IBM under the trademark DB2. The directory server can also be embodied by a plurality of computers cooperating together and appearing as a single directory server.

In one embodiment, groups or communities are formed as a result of users identifying other users with similar information resources, similar interests, or other common characteristics. These groups may form as a result of users indicating a desire to join such a group, or the groups may form as users discover common characteristics. This grouping may be representative of a first user having knowledge of how to contact a second user and means to contact the second user (such as contacting the second user through use of the Internet for example). It will be appreciated that other methods of forming groups may also exist. U.S. application Ser. No. ______, “Online Live Search Systems” on September 11, by the inventors thereof, discloses a method and system for forming a community that can be used to implement the present invention.

In another embodiment, a trusted matchmaking application with broad access rights to public files could analyze the public files of a large group and recommend matches based on the analysis. For example, if there was a fan club for a particular interest area and there is an analyzed file with an indication of numerous references/links to that particular interest area then an invitation could be sent out to join a community through a gateway member.

Examples of community content which could be accessed includes but is not limited to auction items and bids and any associated information required to interact and complete transactions (i.e., community contact list, community member public files, community specific network applications, Uniform Resource Locators (member and community specific), dedicated communication and community bulletin boards).

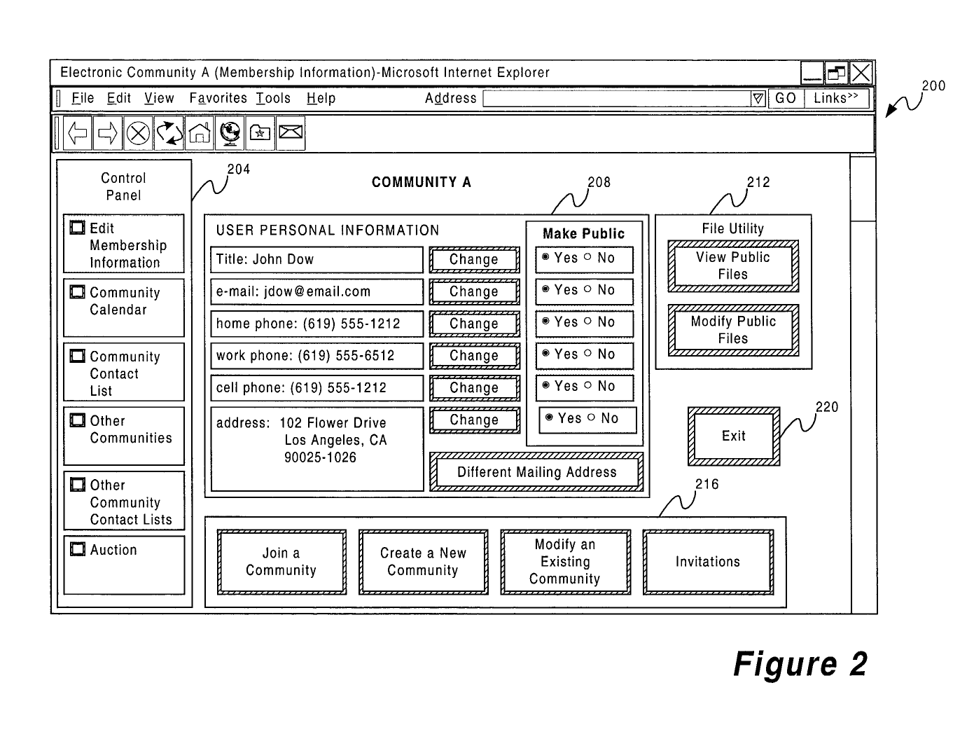

FIGS. 2 illustrates a representative user interface application 200 (a browser application such as Netscape Navigator or Internet Explorer) associated with entering and maintaining community membership information which may be used in conjunction with an embodiment of the present invention. The membership interface application 200 is comprised of a control panel 204, a member identification maintenance panel 208, a file utility 212, a community administrative utility 216 and other control elements (i.e., exit control element 220). Control panel 204 is comprised of a plurality of application interface elements which provide access to the various application pages and utilities associated with a community interactions such as a membership application page (shown), access to a community calendar area, own community contact lists, access to applications pages for communities accessed through a gateway member, other community contact lists, and a community auction billboard.

Member identification maintenance panel 208 facilities the input and sharing of member identification and personal information. File utility 212 is a file sharing utility which facilitates the designation of dedicated individual member files and storage areas (or mirror copies thereof) for community sharing as will be described below. Community administrative utility 216 facilitates community registration and provides community administrative functions such as invitations. Through this application page, a new member can join an existing community, create a new one or an existing member can modify their personal information and designate files for sharing.

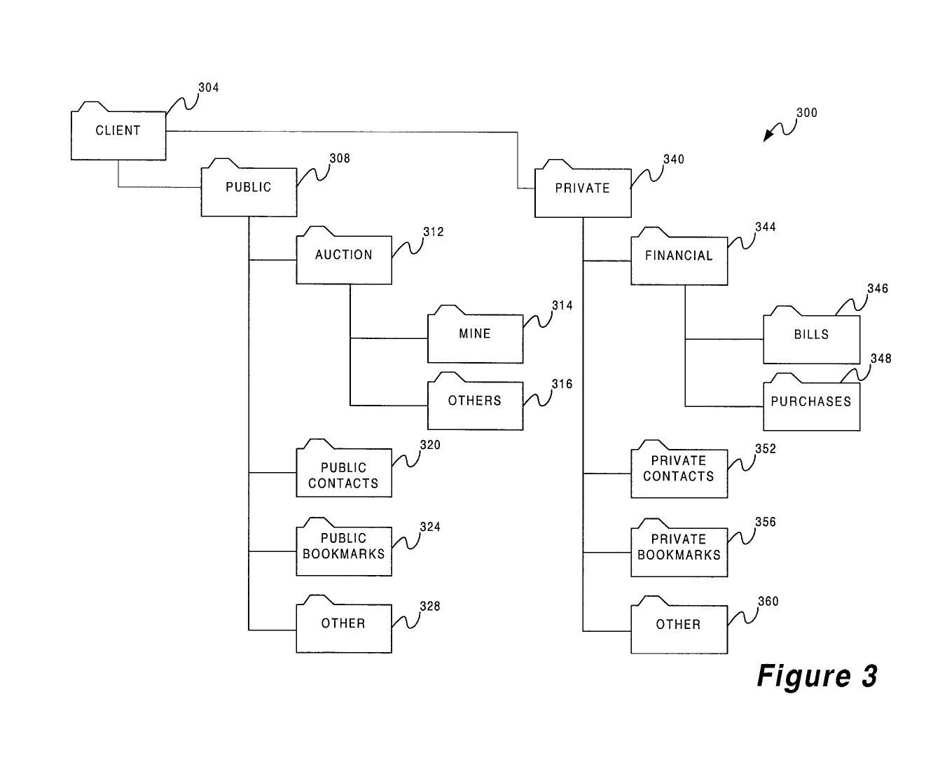

FIG. 3 illustrates a representative file setup which may be used to segregate member files 300 into a public directory 308 and a private directory 340 which may be used in conjunction with an embodiment of the present invention. Designated member files may be made available to other members of the user's own community only or may be made conditionally available to both community and community-proxy members with controls and use rules provided by the user or the user's community administrator. It is important to note at this point that the user's public files may be accessed directly or mirror copies of the user's public files may be accessed with these mirror images being resident on the user's terminal device or on a remote server device (i.e., community server device 132 of FIG. 1).

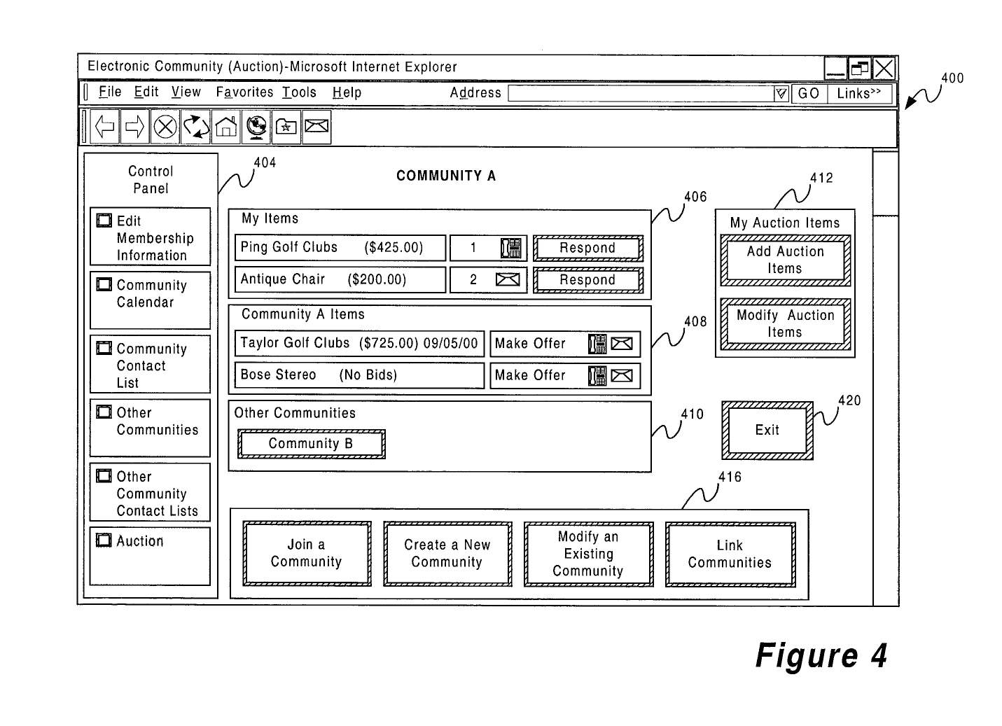

FIG. 4 illustrates a representative user interface application (a browser application such as Netscape Navigator or Internet Explorer) associated with interacting with a community online auction which may be used in conjunction with a preferred embodiment of the present invention. The auction interface application 400 is comprised of a control panel 404, a member's item for auction panel 406, a community auction panel 408 associated with the member's community, a proxy-community auction panel 410 associated with gateway members, an auction item utility 412 and a community administrative utility 416 and other control elements (i.e., exit control element 420). Control panel 404 is comprised of a plurality of application interface elements which provide access to the various application pages and utilities associated with a community interactions such as a membership application page, access to a community calendar area, own community contact lists, access to applications pages for communities accessed through a gateway member, other community contact lists, and a community auction billboard.

The member's item for auction panel 406 provides the member with the current bid and contact buttons (i.e., email or phone) for bidders who have made bids on the member's items for auction. Community auction panel 408 provides the member with information relating to auction items available from the other members of the member's community. Proxy-community auction panel 410 provides the member with information relating to auction items available from communities that are through gateway members. Auction item utility 412 provides functions that enable a user to add and manage the member's auction items. Community administrative utility 416 facilitates community registration and provides community administrative functions such as invitations. Through this application page, a new member can join an existing community, create a new one or an existing member can modify their personal information and designate files for sharing. The auction interface is presented for purposes of illustration and not limitation. The present invention may be applied to any auction environment where communities of members are merged using relationships with other members that are common to the merged communities.

As previously described, the sharing of content (i.e., directories, links, files etc.) between community members (i.e., client members and gateway members) may be carried in a Lightweight Device Access Protocol (LDAP) client-server environment. In LDAP client server environments global directories are generates from a distributed directories. The LDAP protocol is described in RFC 1777, 1959, 1960 and 2251 that are hereby incorporated by reference.

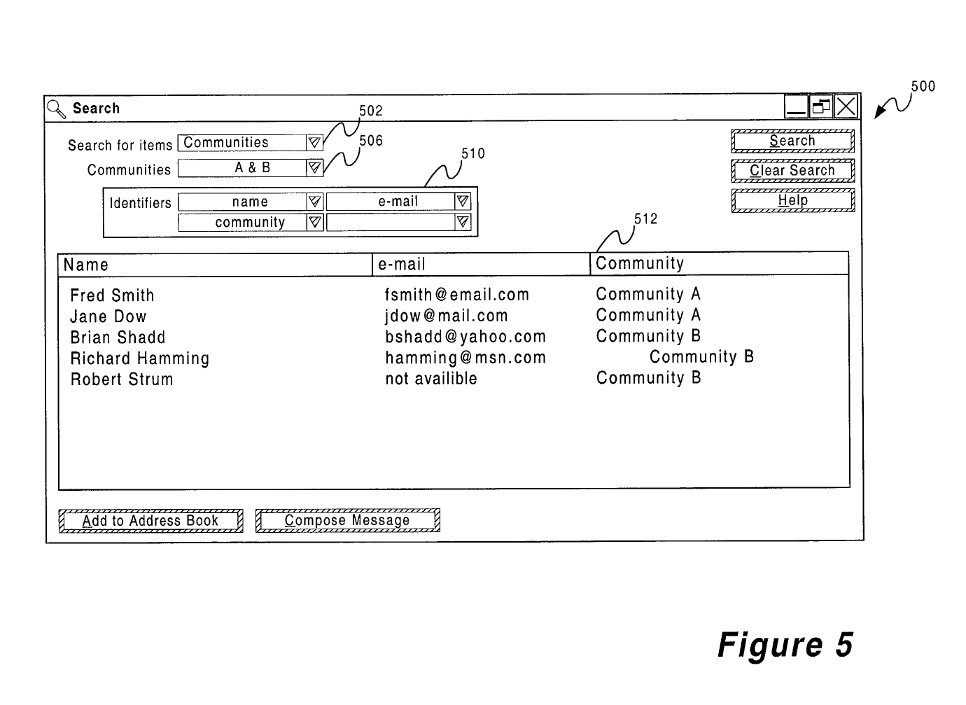

FIG. 5 illustrates a representative user interface application 500 (a search utility) associated with a composite community email list which may be used in conjunction with an embodiment of the present invention. According to an embodiment of the present invention, when a client member forwards a request for content (i.e., auction items and bids) relating to the client's own community and any additional communities which are accessible through gateway members then what the client member gets as a response is a global directory containing the requested information. In this example that information is comprised of email identifiers from Virtual community A and Virtual Community B. From the perspective of the client member the two virtual communities appear merged. It is important to note at this point that there may be restrictions applied to the content that is provided through a proxy entity. For instance, the email address for Robert Strum is not available to the client member because of an access restriction which may have been imposed by Mr. Strum or the administrator for Virtual Community B.

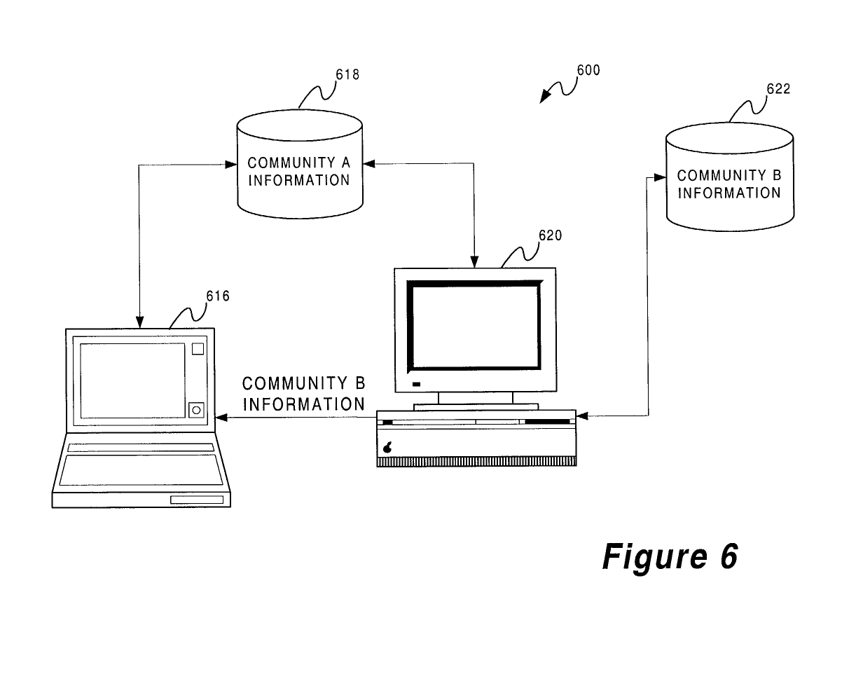

FIG. 6 illustrates a representative conceptualization of the relationship between client member terminal device 616 (which may be client member terminal device 116 of FIG. 1) and a gateway member terminal device 620 (which may be gateway member terminal device 120 of FIG. 1) in conjunction with an embodiment of the present invention. Client member terminal device 616 and gateway member terminal device 620 both have member access rights (i.e., read and modify) to the content and resources of Virtual Community A 618. Gateway member terminal device 620 also has member access rights (i.e., read and modify) to the content and resources of Virtual Community B 622. If client member terminal device 616 requests proxy-member rights (i.e., read only) to the content and resources of Virtual Community B 622 through gateway member terminal device 620, then client member terminal device 616 is the LDAP client and gateway member terminal device 620 is the LDAP server. It is important to note at this point that there may be use conditions and/or restrictions associated with content that client member terminal device 616 may access as a proxy-community member. Additionally, the content accessible to client member terminal device 616 may be a mirror image of the original information which is accessible to gateway member terminal device 620.

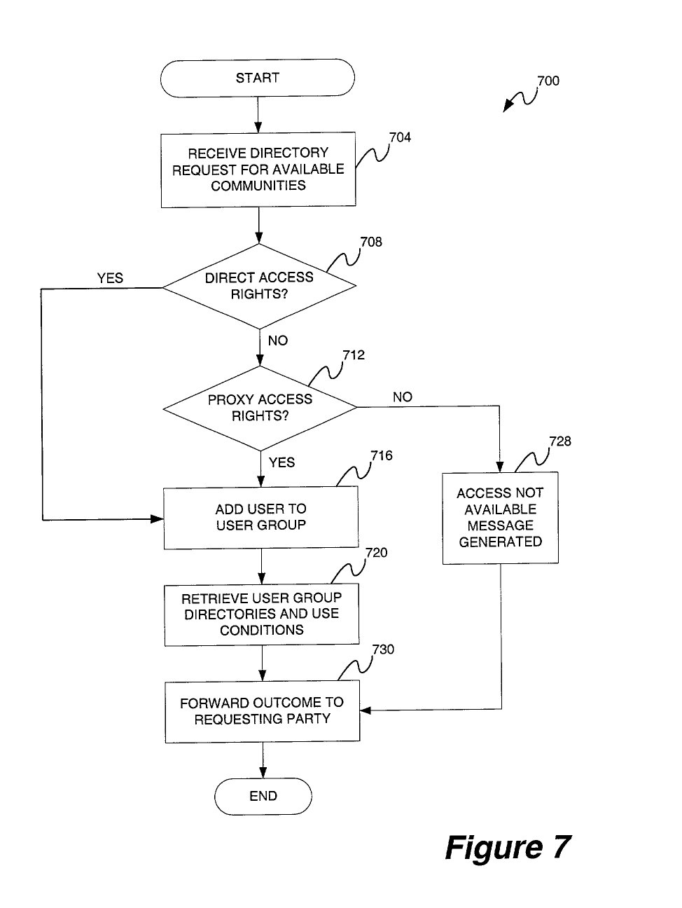

FIG. 7 is flow diagram of the process 700 associated with responding to a request for content from community and non-community members in accordance with an embodiment of the present invention. At 704 a request is received for directories for available communities. At 708 a determination is made as to whether the requester has direct/member access rights. If the requestor has direct access rights then they are added to the current active user group at 716 and the requested content and associated use conditions are retrieved at 720. The retrieved content and associated use conditions are forwarded to the requesting party at 724.

If the requestor does not have direct/member access rights then at 712 a determination is made as to whether the requestor has proxy member access rights. If the requester has proxy member access rights then they are added to the current active user group at 716 and the requested content and associated use conditions are retrieved at 720. The retrieved content and associated use conditions are forwarded to the requesting party at 730. If the requestor does not have proxy member access rights then an access denied message is generated at 726 and forwarded to the requesting party at 730.

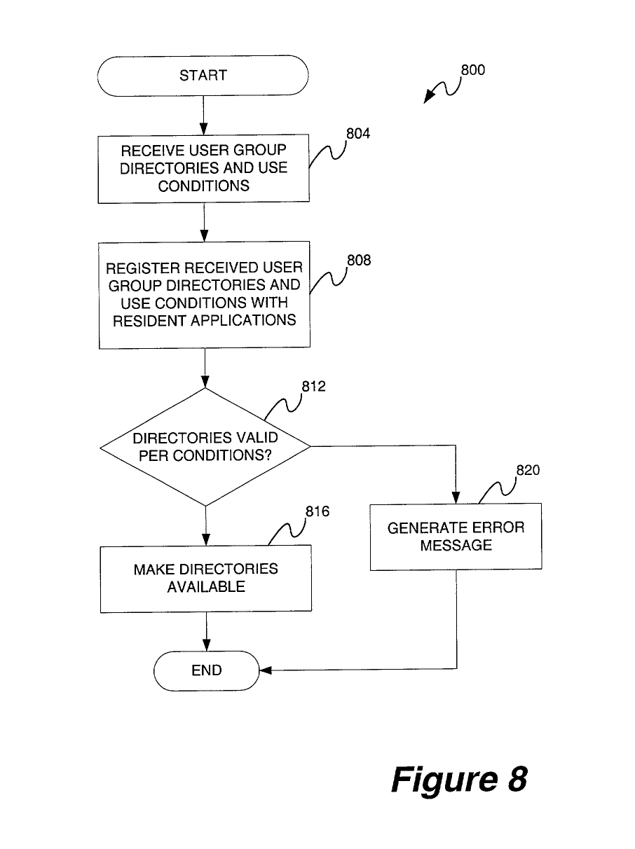

FIG. 8 is flow diagram of the process 800 associated with local processing of received content in accordance with an embodiment of the present invention. At 804 the requested directories and associated use conditions are received. At 808 the received content is registered with the resident applications on the subject terminal device. At 812 a determination is made as to whether the received content may be used as required by the associated use conditions. If the use conditions are not violated then the received content/directories are made available.

The advantages of the invention are numerous. Different embodiments or implementations may yield one or more of the following advantages. One advantage of the present invention is that the members of the linked communities are in control of the rules and conditions governing interactions in the linked auction communities. Still another advantage of the present invention is community information can be segregated into public and non-public storage areas with item-level control of the information.

The many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be considered to fall within the scope of the invention.

We claim:

1. A method for providing an online auction platform, the method comprising:
accessing a list of items being auctioned among a first group of members;
generating a request from a first member, the request including one of the items and a bidding price, wherein the first member is one of the members; and
receiving a response from an owner of one of the items.

2. The method of claim 1 wherein the first group of members is formed by identifying each other with one or more of: (i) similar information resources, (ii) similar interests, (iii) pre-existing relationships, and (iv) common characteristics.

3. The method of claim 1 wherein the first group of members is formed as a result of the members (i) indicating a desire to join the first group, (ii) being invited to join the first group, or (iii) discovering common characteristics among each other.

4. The method of claim 1 further comprising:
joining in the first group by contacting one of the members in the first group.

5. The method of claim 4 wherein the contacting one of the members includes:
sending a message the one of the members, the message including identity information and characteristics information having affinity with the first group.

6. The method of claim 1 wherein the owner is one of the members and wherein the owner determines if the bidding price is acceptable after comparing the bidding price with other offers, if there are any.

7. The method of claim 6, wherein the response includes one of: (i) the bidding price is accepted, and (ii): a higher bidding price has arrived.

8. The method of claim 1, wherein the accessing a list of items being auctioned includes:
executing an application to retrieve the list of items being auctioned, and displaying the list of items in a display application.

9. The method of claim 8 wherein the application sends out respective retrieval requests, each to one of the members to collect the items being auctioned among the first group using a directory access protocol over a network.

10. The method of claim 9 wherein the directory access protocol is one of (i) Lightweight Device Access Protocol, (ii) DBMS protocol, or (iii) other filesharing protocol such as Napster, Gnutella, HTTP, and an extension therof.

11. The method of claim 9 wherein the network is selected from a group consisting of (i) the Internet, (ii) the Intranet, (iii) a wireless network, and (iv) a combined public and private network.

12. The method of claim 1 wherein the owner is one of a second group of members, wherein the first and second groups do not necessarily have anything in common and wherein one of the first group of members is one of the second group of members, as a gateway member.

13. The method of claim 12 wherein the request is passed to the second group of members via the gateway member.

14. The method of claim 13 further comprising updating the list of items to include any items being auctioned in the second group of members.

15. A method for providing an online auction platform, the method comprising:
accessing a list of items being auctioned among a group of members;
adding an item to the list for auction;
sending out the list so that the members in the group receive the updated list;
receiving a bidding price for the item from one of the group of members; and
generating a response to the request once a decision to the bidding price is made.

16. The method of claim 15, wherein the accessing a list of items includes:
generating respective retrieval requests, each to one of the members to collect auction content information using a directory access protocol over a network.

17. The method of claim 16 wherein the directory access protocol is one of (i) Lightweight Device Access Protocol, (ii) DBMS protocol or (iii) other filesharing protocol such as Napster, Gnutella, HTTP, and an extension thereof.

18. The method of claim 16 wherein the network is selected from a group consisting of (i) the Internet, (ii) the Intranet, (iii) a wireless network, and (iv) a combined public and private network.

19. The method of claim 15, wherein the generating a response to the request comprises:
keeping receiving multiple bidding prices respectively from some of the members, the bidding price being one of the multiple bidding prices;
ordering the multiple bidding prices; and
generating the response when one of the multiple bidding prices is selected.

20. The method of claim 19, wherein the response is an acceptance of the bidding price.

21. The method of claim 19, wherein the response includes a higher bidding price from another member in the group.

22. The method of claim 15, wherein the members are from a first and a second community, one of the members, as a gateway member, belongs commonly to the first and second communities.

23. The method of claim 16 wherein each of the first and second communities is respectfully formed by identifying each other member therein with one or more of: (i) similar information resources, (ii) similar interests, (iii) pre-existing relationships, and (iv) common characteristics.

24. The method of claim 16 wherein each of the first and second communities is respectfully formed as a result of the members (i) indicating a desire to join one or both of the two communities, (ii) being invited to join one or both of the two communities, or (iii) discovering common characteristics among each other member.

25. A system for providing an online auction platform, the system comprising:
a memory means for storing program code for generating requests associated with an online auction using a file access protocol, access rights associated with a first virtual community, device program applications and a plurality of user files;
a user interface including a character input interface, a pointing device and a display; and
processing means connected to the memory means and the user interface and responsive to an input provided by a user to generate requests for content relating to an item being auctioned using a file transfer protocol, forward the request through a communications network to a second terminal device, process responses received from the second terminal device containing the requested content relating to the item.

26. The system of claim 25, wherein the directory access protocol is one of (i) Lightweight Device Access Protocol, (ii) DBMS protocol or (iii) other filesharing protocol such as Napster, Gnutella, HTTP, and an extension thereof.

27. The system of claim 25, wherein the communications network includes one or more of a network and a wireless communications network.

28. The system of claim 25, wherein the program code is an executed version of an application selected from a group consisting of a browser application, an email application, an instant messaging application, a net meeting application and a network game interface.
